(19) United States
(12) Patent Application Publication
(10) Pub. No.: US 2005/0079421 A1
(43) Pub. Date: Apr. 14, 2005

(54) Anode and battery

(76) Inventors: Isamu Konishiike, Fukushima (JP); Takeru Yamamoto, Fukushima (JP); Tomoo Takada, Fukushima (JP); Kenichi Kawase, Fukushima (JP); Yukio Miyaki, Kanagawa (JP)

Correspondence Address: ROBERT J. DEPKE LEWIS T. STEADMAN;HOLLAND & KNIGHT LLC, 131 SOUTH DEARBORN, 30TH FLOOR, CHICAGO, IL, 60603, US

(21) Appl. No.: 10/935,827

(22) Filed: Sep. 8, 2004

(30) Foreign Application Priority Data
Sep. 9, 2003 (JP) JP2003-317399
Sep. 9, 2003 (JP) JP2003-317400

(51) Int. Cl. H01M 4/40; H01M 4/66

(52) U.S. Cl. 429/231.95; 429/245

(57) ABSTRACT

The invention provides an anode capable of improving battery characteristics such as cycle characteristics and a battery using it. An anode current collector is provided with an anode active material layer. The anode active material layer contains at least one from the group consisting of simple substances, alloys, and compounds of silicon or the like capable of forming an alloy with Li. Further, the anode active material layer is formed by vapor-phase deposition method or the like, and is alloyed with the anode current collector. Further, Li of from 0.5% to 40% of an anode capacity is previously inserted in the anode active material layer. Therefore, when Li is consumed due to reaction with an electrolyte or the like, Li can be refilled, and potential raise of the anode can be inhibited in the final stage of discharge.

### BACKGROUND OF THE INVENTION

1. Field of the Invention

The present invention relates to an anode having an anode current collector and an anode active material layer, and a battery using it.

2. Description of the Related Art

In recent years, in connection with high-performance and multi-function of mobile devices, high capacities of secondary batteries, the power source for the mobile devices have been desired earnestly. As a secondary battery which meets this demand, there is a lithium secondary battery. However, in the case of using cobalt acid lithium for a cathode and graphite for an anode, which is currently a typical type for the lithium secondary batteries, the battery capacity is in a saturated state, and it is extremely difficult to greatly obtain a high capacity of the battery. Therefore, from old times, using metallic lithium (Li) for an anode has been considered. However, in order to put this anode to practical use, it is necessary to improve efficiency of precipitation dissolution of lithium and to control dendrite precipitation form.

Meanwhile, a secondary battery which uses a high capacity anode using silicon (Si), germanium (Ge), tin (Sn) or the like has been actively considered recently. However, when charge and discharge are repeated, these high capacity anodes are pulverized and miniaturized due to significant expansion and shrinkage of an anode active material, current collecting characteristics are lowered, and dissolution reaction of an electrolytic solution is promoted due to an increased surface area, so that their cycle characteristics are extremely poor. Meanwhile, when an anode wherein an active material layer is formed on a current collector by vapor-phase deposition method, liquid-phase deposition method, firing method or the like is used, miniaturization can be inhibited compared to conventional coating type anodes which are coated with a slurry containing a particulate active material, a binder and the like, and the current collector and the active material layer can be integrated. Therefore, electronic conductivity in the anode becomes extremely excellent, and high performance in terms of capacity and cycle life is expected. In addition, a conductive material, a binder, voids and the like which have conventionally existed in the anode can be reduced or excluded. Therefore, the anode can become a thin film essentially.

However, even when using this anode, the cycle characteristics are not sufficient due to a nonreversible reaction of the active material with charge and discharge. Further, reactivity to an electrolyte is still high as in the conventional high capacity anode. The reaction with the electrolyte with charge and discharge causes significant deterioration of the capacity particularly at early cycles. Further, in these high capacity anodes, as lithium is extracted, anode potential is significantly raised particularly in the final stage of discharge, which is one of the causes of deterioration of characteristics.

In order to solve these problems, a method wherein lithium involved in battery reaction is previously inserted in the anode can be considered. In conventional lithium ion secondary batteries using carbon for anodes, many techniques that a given amount of lithium is previously inserted in the anode have been reported. For example, an anode which uses particles having a structure in which a metallic lithium layer and a carbon layer are layered alternately (refer to Japanese Unexamined Patent Application Publication No. H07-326345); an anode in which an alkali metal is electrochemically supported by a thin layer made of a transition metal chalcogen compound or a carbon material (refer to Japanese Patent Publication No. 3255670); an anode in which lithium is diffused and held in a carbon material by bonding a metallic lithium foil (refer to Japanese Patent Publication No. 3063320); an anode in which lithium is introduced by injecting an electrolytic solution and short-circuiting metallic lithium and a carbon material (refer to Japanese Unexamined Patent Application Publication No. H10-270090); a lithium secondary battery in which aromatic carbon hydride which forms a complex with metallic lithium is added to an anode in which metallic lithium is short-circuited to a carbon material (refer to Japanese Unexamined Patent Application Publication No. H11-185809); and a lithium secondary battery which has a supply member made of metallic lithium which is provided without electrical connection to the anode in a battery case (refer to Japanese Unexamined Patent Application Publication No. 2001-297797) have been reported.

In these carbonaceous anodes, an irreversible capacity portion of the carbon material can be improved by previously inserting lithium. However, the carbonaceous anode generally has high charge and discharge efficiency differently from the foregoing high capacity anode, and has small lithium insertion amount. Therefore, previous insertion of lithium leads to significant lowering of the anode capacity, that is, there is little benefit in view of actual energy density.

Further, regarding anodes other than the carbonaceous anodes, for example, an anode in which lithium injection treatment is previously performed for an anode material made of silicon or germanium by using an ion injection apparatus (refer to Japanese Unexamined Patent Application Publication No. 2002-93411); and a battery in which both a cathode and an anode are fabricated in a state that alkali metal ions can be inserted in both the cathode and the anode, an alkali metal is inserted in the cathode and the anode by bringing the cathode and the anode into contact with a dispersion liquid in which the alkali metal is dispersed in an organic solvent containing a compound capable of solvating with the alkali metal ions or forming a complex with the alkali metal ions (refer to Japanese Unexamined Patent Application Publication No. H11-219724) have been reported.

In the technique described in the Japanese Unexamined Patent Application Publication No. 2002-93411, a density of lithium ions previously injected is a minute amount, that is, about from 1×10¹⁶ ions/cm³ to 1×10¹⁸ ions/cm³. Therefore, these injected lithium ions cannot play a role as a reservoir to compensate cycle deterioration, and the effect thereof is small. Further, as diagrammatically shown in the Japanese Unexamined Patent Application Publication No. 2002-93411, when the ion injection apparatus which performs a small amount of doping by using plasma is used, an apparatus composition becomes complicated, and it is difficult to simply inject a certain amount of lithium with which effect can be obtained. Further, in the Japanese Unexamined Patent Application Publication No. H11-21972, both the cathode and the anode are fabricated in a state that the alkali metal can be inserted into their active materials, that is, a discharge starting type cathode is used. The technique thereof is not intended to improve characteristics by previously inserting lithium excessive compared to a lithium amount involved in battery reaction into the anode.

### SUMMARY OF THE INVENTION

The invention has been achieved in consideration of such problems, and it is an object of the invention to provide an anode capable of improving battery characteristics such as cycle characteristics by inserting lithium in the anode, and a battery using it.

A first anode according to the invention is an anode comprising: an anode current collector; and an anode active material layer which is provided on the anode current collector and is alloyed with the anode current collector at least at part of an interface with the anode current collector, wherein lithium of from 0.5% to 40% of an anode capacity is inserted therein.

A second anode according to the invention is an anode comprising: an anode current collector; and an anode active material layer which is formed on the anode current collector by at least one method from the group consisting of vapor-phase deposition method, liquid-phase deposition method, and firing method, wherein lithium of from 0.5% to 40% of an anode capacity is inserted therein.

A first battery according to the invention is a battery comprising: a cathode; an anode; and an electrolyte, wherein the anode comprises an anode current collector and an anode active material layer which is provided on the anode current collector and is alloyed with the anode current collector at least at part of an interface with the anode current collector, and lithium of from 0.5% to 40% of an anode capacity is inserted therein before initial charge and discharge.

A second battery according to the invention is a battery comprising: a cathode; an anode; and an electrolyte, wherein the anode comprises an anode current collector and an anode active material layer which is formed on the anode current collector by at least one method from the group consisting of vapor-phase deposition method, liquid-phase deposition method, and firing method, and lithium of from 0.5% to 40% of an anode capacity is inserted therein before initial charge and discharge.

A third battery according to the invention is a battery comprising: a cathode; an anode; and an electrolyte, wherein the anode comprises an anode current collector and an anode active material layer which is provided on the anode current collector and is alloyed with the anode current collector at least at part of an interface with the anode current collector, and has therein electrochemically active residual lithium after discharge.

A fourth battery according to the invention is a battery, comprising: a cathode; an anode; and an electrolyte, wherein the anode comprises an anode current collector and an anode active material layer which is formed on the anode current collector by at least one method from the group consisting of vapor-phase deposition method, liquid-phase deposition method, and a firing method, and has therein electrochemically active residual lithium after discharge.

According to the anode of the invention, lithium of 0.5% to 40% of the anode capacity is inserted. Therefore, for example, when the anode is applied to the battery of the invention, consumption of lithium due to reaction with an electrolytic solution or the like at the early cycles can be inhibited. Even when lithium is consumed, lithium can be refilled, and early deterioration can be inhibited. Further, potential raise of the anode can be inhibited in the final stage of discharge, and deterioration with the potential raise of the anode can be inhibited. Further, by previously inserting lithium, stress on the anode current collector due to expansion and shrinkage of the anode active material layer with charge and discharge can be reduced. Therefore, battery characteristics such as cycle characteristics can be improved.

In particular, when an insertion amount of lithium is in the range from 0.02 μm to 20 μm per unit area by converting to a thickness of metallic lithium, higher effects can be obtained, and handling characteristics and manufacturing characteristics can be improved.

Further, when lithium is inserted by depositing metallic lithium by vapor-phase deposition method, lithium can be inserted in the process of depositing metallic lithium, and handling becomes easy. Further, an amount of lithium to be inserted can be easily controlled, and lithium can be inserted uniformly over a large area. Further, when the anode active material layer is deposited by vapor-phase deposition method, deposition of the anode active material layer and lithium insertion process can be continuously performed, and therefore, manufacturing processes can become simplified.

Further, when the anode active material layer contains at least one from the group consisting of simple substances, alloys, and compounds of silicon or germanium, a high capacity can be obtained, and capacity loss due to previous insertion of lithium can be reduced. Further, by inserting lithium, dangling bond or impurities such as hydrogen and oxygen, which exist in the anode active material layer can be reduced, and battery characteristics such as cycle characteristics can be improved.

According to other batteries of the invention, electrochemically active lithium remains in the anode after discharge. Therefore, even when lithium is consumed due to reaction with the electrolytic solution or the like, lithium can be refilled and deterioration can be inhibited. Further, potential raise of the anode in the final stage of discharge can be further inhibited, and deterioration with the potential raise of the anode can be inhibited. In the result, battery characteristics such as cycle characteristics can be improved.

Other and further objects, features and advantages of the invention will appear more fully from the following description.

### BRIEF DESCRIPTION OF THE DRAWINGS

FIG. 1 is a cross sectional view showing a construction of an anode according to an embodiment of the invention;

FIG. 2 is a cross sectional view showing a construction of a secondary battery using the anode shown in FIG. 1;

FIG. 3 is an exploded perspective view showing a construction of other secondary battery using the anode shown in FIG. 1; and

FIG. 4 is a cross sectional view showing a construction taken along line I-I of an electrode winding body shown in FIG. 3.

### DETAILED DESCRIPTION OF THE PREFERRED EMBODIMENT

An embodiment of the invention will be described in detail hereinafter with reference to the drawings.

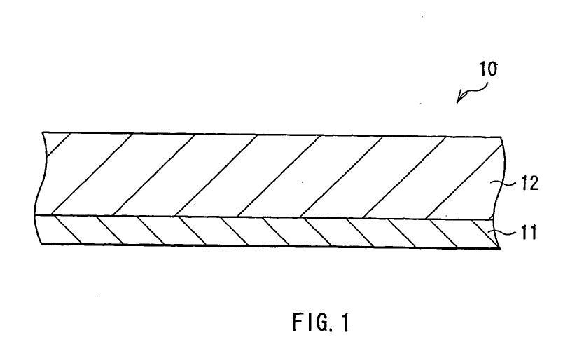

FIG. 1 shows a simplified construction of an anode according to the embodiment of the invention. An anode 10 has, for example, an anode current collector 11 and an anode active material layer 12 provided on the anode current collector 11. The anode active material layer 12 can be formed on both sides or a single side of the anode current collector 11.

The anode current collector 11 is preferably made of a metal material containing at least one of metal elements which do not form an intermetallic compound with lithium. When the intermetallic compound is formed with lithium, expansion and shrinkage arise with charge and discharge, structural destruction arises, and current collecting characteristics become lowered. In addition, an ability to support the anode active material layer 12 becomes small, and therefore, the anode active material layer 12 easily separates from the anode current collector 11. In this specification, the metal material includes not only simple substances of metal elements, but also alloys made of two or more metal elements, or alloys made of one or more metal elements and one or more semimetal elements. Examples of the metal element which does not form an intermetallic compound with lithium include copper (Cu), nickel (Ni), titanium (Ti), iron (Fe), and chromium (Cr).

Specially, metal elements which are alloyed with the anode active material layer 12 are preferable. As described below, when the anode active material layer 12 contains a simple substance, an alloy, or a compound of silicon, germanium, or tin, which is alloyed with lithium, the anode active material layer 12 significantly expands and shrinks with charge and discharge, and therefore, the anode active material layer 12 easily separates from the anode current collector 11. However, the separation can be inhibited by tightly bonding the anode active material layer 12 and the anode current collector 11 by alloying therebetween. As a metal element which does not form an intermetallic compound with lithium, and which is alloyed with the anode active material layer 12, for example, as a metal element which is alloyed with a simple substance, an alloy or a compound of silicon, germanium or tin, copper, nickel, and iron can be cited. Specially, in view of alloying with the anode active material layer 12, strength, and conductivity, copper, nickel, or iron is preferable.

The anode current collector 11 can be composed by a single layer, or several layers. In the latter case, it is possible that a layer which contacts with the anode active material layer 12 is made of a metal material which is alloyed with a simple substance, an alloy, or a compound of silicon, germanium, or tin; and the other layers are made of other metal materials. Further, the anode current collector 11 is preferably made of a metal material made of at least one of metal elements which do not form an intermetallic compound with lithium, except for an interface with the anode active material layer 12.

The anode active material layer 12 contains, for example, at least one from the group consisting of simple substances, alloys, compounds of elements capable of forming an alloy with lithium as an anode active material. Specially, as an anode active material, at least one from the group consisting of simple substances, alloys, and compounds of silicon, germanium, or tin is preferably contained. In particular, simple substance, alloys, and compounds of silicon are preferable. The simple substance, alloys, and compounds of silicon have a high ability to insert and extract lithium, and can raise an energy density of the anode 10 compared to conventional graphite according to combination thereof. Specially, simple substance, alloys, and compounds of silicon have low toxicity and are inexpensive.

Examples of the alloy or compound of silicon include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2) and LiSiO.

Examples of the compound of germanium include Ge₃N₄, GeO, GeO₂, GeS, GeS₂, GeF₄, and GeBr₄. Examples of the compound or alloy of tin include alloys between tin and elements included in Groups 4 to 11 in the long-period periodic table. In addition, Mg₂Sn, SnO_{w} (0<w≦2), SnSiO₃, and LiSnO can be cited.

The anode active material layer 12 is preferably formed by at least one method from the group consisting of vapor-phase deposition method, liquid-phase deposition method, and firing method. The reason thereof is that destruction due to expansion and shrinkage of the anode active material layer 12 with charge and discharge can be inhibited, the anode current collector 11 and the anode active material layer 12 can be integrated, and electronic conductivity in the anode active material layer 12 can be improved. In addition, a binder, voids and the like can be reduced or excluded, and the anode 10 can become a thin film. In the specification, “forming the anode active material by firing method” means forming a denser layer having a higher volume density than before heat treatment by performing heat treatment for a layer formed by mixing powders containing an active material and a binder under a non-oxidizing atmosphere or the like.

Further, the anode active material 12 is preferably alloyed with the anode current collector 11 a least at part of the interface with the anode current collector 11, in order to prevent the anode active material 12 from separating from the anode current collector 11 due to expansion and shrinkage. Specifically, it is preferable that at the interface therebetween, a component element of the anode current collector 11 is diffused in the anode active material layer 12, or a component element of the anode active material layer 12 is diffused in the anode current collector 11, or the both component elements are diffused in each other. This alloying often arises concurrently with forming the anode active material layer 12 by vapor-phase deposition method, liquid-phase deposition method, or firing method. However, it is possible that this alloying arises by further heat treatment. In this specification, the diffusion of elements described above is included in alloying.

It is preferable that lithium is previously inserted in the anode active material layer 12 when, for example, assembly is performed, that is, before initial charge (before initial charge and discharge). The reason thereof is that even when lithium is consumed due to reaction with an electrolyte in a battery or the like, lithium can be refilled; and potential raise of the anode 10 can be inhibited in the final stage of discharge. In addition, by previously inserting lithium, stress on the anode current collector 11 due to expansion and shrinkage with charge and discharge can be reduced. Further, when the anode active material layer 12 contains a simple substance, an alloy, or a compound of silicon or germanium, dangling bond or impurities such as hydrogen and oxygen, which exist in the anode active material layer 12, can be reduced.

An amount of lithium previously inserted in the anode active material layer 12 is preferably from 0.5% to 40% of an anode capacity. When the amount is under 0.5%, large effect cannot be obtained. Meanwhile, when the amount is over 40%, the capacity is lowered, and the anode is incurvated by stress with alloying between the anode active material and lithium, leading to lowering of handling characteristics and manufacturing characteristics.

The amount of lithium previously inserted in the anode active material layer 12 is more preferably from 0.02 μm to 20 μm per unit area by converting to a thickness of metallic lithium. Though depending on manufacturing methods, when the amount is under 0.02 μm per unit area, lithium loses activity due to oxidation by a handling atmosphere, and therefore, sufficient effect cannot be obtained. Meanwhile, when the amount is over 20 μm, the anode active material layer 12 becomes thick, stress on the anode current collector 11 becomes significantly large, and further, handling characteristics and manufacturing characteristics become extremely lowered depending on manufacturing methods.

Further, it is preferable that electrochemically active lithium remains in the anode active material layer 12 after discharge at least at early charge and discharge cycles. The reason thereof is that the effect to refill lithium and effect to inhibit potential raise of the anode 10 in the final stage of discharge, which are described above, can be improved. It is enough that this electrochemically active lithium remains at least after the initial discharge. However, it is more preferable that this electrochemically active lithium remains up to after discharge at the third cycle, since capacity deterioration at early cycles such as the third cycle is significant in the anode 10. Needless to say, it is possible that the electrochemically active lithium remains after discharge at the cycles on and after the third cycle.

In order to make the electrochemically active lithium remain in the anode active material layer 12 after discharge, for example, the amount of lithium previously inserted in the anode active material layer 12 is preferably 5% or more of the anode capacity.

Whether the electrochemically active lithium remains in the anode 10 or not is verified by, for example, deconstructing the secondary battery after discharge to take out the anode 10, fabricating a half cell in which a counter electrode is a metal foil or the like capable of precipitation of metallic lithium, and checking whether extraction of lithium from the anode 10 and precipitation of the metallic lithium into the counter electrode are enabled or not. That is, when extraction of lithium from the anode 10 is confirmed, it is judged that the electrochemically active lithium remains in the anode 10. When extraction of lithium from the anode 10 is not confirmed, it is judged that the electrochemically active lithium does not remain in the anode 10. In this regard, shapes of an electrolyte and a half cell to be used can be anything as long as current carrying can be confirmed. Examples of the metal foil to be used as a counter electrode include a lithium foil, a copper foil, and a nickel foil. After the anode 10 is taken out from the battery, the anode 10 can be cleaned with an organic solvent with low reactivity to lithium or the like and dried.

This anode 10 can be manufactured, for example, as follows.

First, for example, the anode current collector 11 made of a metal foil is prepared, and the anode active material layer 12 is deposited on the anode current collector 11 by depositing an anode active material by vapor-phase deposition method or liquid-phase deposition method. The anode active material layer 12 can be deposited by firing method, after a precursor layer containing a particulate anode active material is formed on the anode current collector 11, and then the resultant is fired. Further, the anode active material layer 12 can be deposited by combining two or three methods of vapor-phase deposition method, liquid-phase deposition method, and firing method. By using at least one method mentioned above, the anode active material layer 12 which is alloyed with the anode current collector 11 at least at part of an interface with the anode current collector 11 is deposited. In order to further alloy the interface between the anode current collector 11 and the anode active material layer 12, heat treatment can be further performed under a vacuum atmosphere or a non-oxidizing atmosphere. In particular, when the anode active material layer 12 is deposited by plating, alloying is difficult in some cases, and therefore, this heat treatment is preferably performed according to need. When deposition is performed by vapor-phase deposition method, characteristics may be improved by further alloying the interface between the anode current collector 11 and the anode active material layer 12, and therefore, this heat treatment is preferably performed according to need.

As vapor-phase deposition method, physical deposition method or chemical deposition method can be cited. Specifically, vacuum deposition method, sputtering, ion plating method, laser ablation method, CVD (Chemical Vapor Deposition) method or the like can be cited. As liquid-phase deposition method, known techniques such as electrolytic plating and electroless plating can be used. Regarding firing method, known techniques can be used. For example, atmosphere firing method, reaction firing method, or hot press firing method can be used.

Next, lithium of from 0.5% to 40% of an anode capacity is previously inserted in the anode active material layer 12. As a method to insert lithium, any of known techniques can be used. For example, insertion can be made by depositing metallic lithium on the surface of the anode active material layer 12 by vapor-phase deposition method, or can be made by bonding a metallic lithium foil or coating with powdery metallic lithium. In addition, insertion can be made by using an aromatic compound which forms a complex with metallic lithium and bringing the lithium complex into contact with the anode active material layer 12, or can be made by electrochemically inserting lithium in the anode active material layer 12.

Specially, the method to insert lithium by depositing metallic lithium by vapor-phase deposition method is preferable. The reasons thereof are as follows. It is highly dangerous to treat highly active powdery metallic lithium. Further, when a solvent is used, for example, in the case of electrochemically inserting lithium, treating the anode becomes poor, and applicability of the battery to manufacturing processes becomes poor. Further, when the vapor-phase deposition method is used, an amount of lithium to be inserted can be easily controlled, lithium can be inserted uniformly over a large area, and even a roll electrode can be continuously processed.

As vapor-phase deposition method, vapor-phase deposition method in which deposition is made by heating a raw material, such as vacuum deposition method and ion plating method is preferable. However, sputtering or the like can be used as well. For example, when the anode active material layer 12 is deposited by vapor-phase deposition method, it is possible to continuously deposit metallic lithium without exposure to an atmosphere depending on apparatuses to be used. This continuous deposition is preferable since existence of excessive moisture and formation of an oxide film can be inhibited. In this case, deposition of the anode active material layer 12 and deposition of metallic lithium can be performed by the same method such as vacuum deposition method. Otherwise, it is possible that different methods are used, for example, the anode active material layer 12 is deposited by sputtering and metallic lithium is deposited by vacuum deposition.

When vapor-phase deposition method is used, the deposited metallic lithium is diffused in the anode active material layer 12 in the process of deposition, alloying proceeds, and lithium is inserted, though depending on a deposition amount and a deposition rate of the metallic lithium. In order to promote diffusion and alloying of lithium into the anode active material layer 12, heat treatment can be further performed under a non-oxidizing atmosphere.

Further, particularly when vapor-phase deposition method is used, it is preferable that an insertion amount of lithium is from 0.02 μm to 20 μm per unit area by converting to a thickness of metallic lithium. As mentioned above, when the amount is under 0.02 μm, sufficient effect cannot be obtained since lithium loses activity due to oxidization as mentioned above. Meanwhile, when the amount is over 20 μm, manufacturing characteristics becomes lowered. In the result, the anode 10 shown in FIG. 1 can be obtained.

This anode 10 is used for, for example, a secondary battery as below.

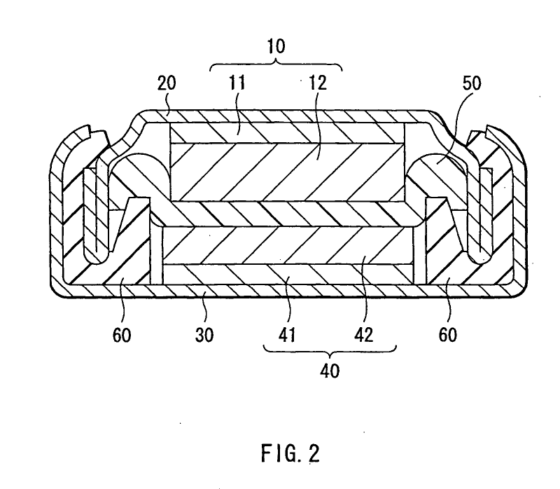

FIG. 2 shows a construction of the secondary battery. This secondary battery is a so-called coin type secondary battery. The anode 10 housed in an exterior cup 20 and a cathode 40 housed in an exterior can 30 are layered with a separator 50 in between. In this secondary battery, lithium is previously inserted in the anode 10 when assembled, that is, before initial charge (before initial charge and discharge).

Peripheral edges of the exterior cup 20 and the exterior can 30 are hermetically closed by caulking through insulating gasket 60. The exterior cup 20 and the exterior can 30 are made of, for example, a metal such as stainless and aluminum, respectively.

The cathode 40 has, for example, a cathode current collector 41 and a cathode active material layer 42 provided on the cathode current collector 41. Arrangement is made so that the cathode active material layer 42 side faces to the anode active material layer 12. The cathode current collector 41 is made of, for example, aluminum, nickel, or stainless.

The cathode active material layer 42 contains, for example, one or more of cathode materials capable of inserting and extracting lithium as a cathode active material. The cathode active material layer 42 can also contain a conductive agent such as a carbon material and a binder such as polyvinylidene fluoride as according to need. As a cathode material capable of inserting and extracting lithium, for example, a lithium-containing metal complex oxide expressed as a general formula of LiₓMIO₂ is preferable. Since the lithium-containing metal complex oxide can generate a high voltage and has a high density, a higher capacity of the secondary battery can be obtained. MI represents one or more transition metals, and is preferably at least one of cobalt and nickel. x varies according to a charge and discharge state of the battery, and is generally in the range of 0.05≦x≦1.10. Concrete examples of the lithium-containing metal complex oxide include LiCoO₂ and LiNiO₂.

This cathode 40 can be fabricated, for example, by forming the cathode active material layer 42 by mixing a cathode active material, a conductive material, and a binder to prepare an admixture, dispersing this admixture in a dispersion solvent such as N-methyl pyrrolidone to form an admixture slurry, coating the cathode current collector 41 made of a metal foil with this admixture slurry, drying the resultant, and then compression-molding the resultant.

A separator 50 is intended to separate the cathode 10 from the anode 40, prevent current short circuit due to contact between the cathode and the anode, and let through lithium ions. The separator 50 is made of, for example, polyethylene or polypropylene.

An electrolytic solution, which is a liquid electrolyte, is impregnated in the separator 50. This electrolytic solution contains, for example, solvent and a lithium salt, which is an electrolyte salt, dissolved in this solvent. The electrolytic solution can also contain additives according to need. Examples of the solvent include organic solvents such as ethylene carbonate, propylene carbonate, dimethyl carbonate, diethyl carbonate, and ethyl methyl carbonate. One or a mixture thereof can be used.

Examples of the lithium salt include LiPF₆, LiCF₃SO₃, and LiClO₄. One or a mixture thereof can be used.

This secondary battery can be manufactured by, for example, layering the anode 10, the separator 50 in which the electrolytic solution is impregnated, and the cathode 40, inserting the layered body in the exterior cup 20 and the exterior can 30, and providing caulking.

In this secondary battery, when charged, for example, lithium ions are extracted from the cathode 40, and are inserted in the anode 10 through the electrolytic solution. When discharged, for example, lithium ions are extracted from the anode 10, and are inserted in the cathode 40 through the electrolytic solution. In this regard, since lithium is previously inserted in the anode 10, a film produced by reaction between lithium and the electrolytic solution before charge and discharge is formed on the surface of the anode 10. Therefore, consumption of lithium supplied by the cathode 40 due to reaction with the electrolytic solution or the like can be inhibited. In addition, even when part of the lithium is consumed, lithium is refilled from the anode 10. Further, in the final stage of discharge, potential raise of the anode 10 is inhibited. Furthermore, stress on the anode current collector 11 due to expansion and shrinkage with charge and discharge is reduced. In the result, superior charge and discharge cycle characteristics can be obtained.

Further, when electrochemically active lithium remains in the anode 10 after discharge at least at early charge and discharge cycles, sufficient lithium is refilled from the anode 10, even when lithium is consumed due to reaction with the electrolytic solution. Furthermore, potential raise of the anode 10 is further inhibited in the final stage of discharge. In the result, more superior charge and discharge characteristics can be obtained.

The anode 10 according to this embodiment can be used for the following secondary battery as well.

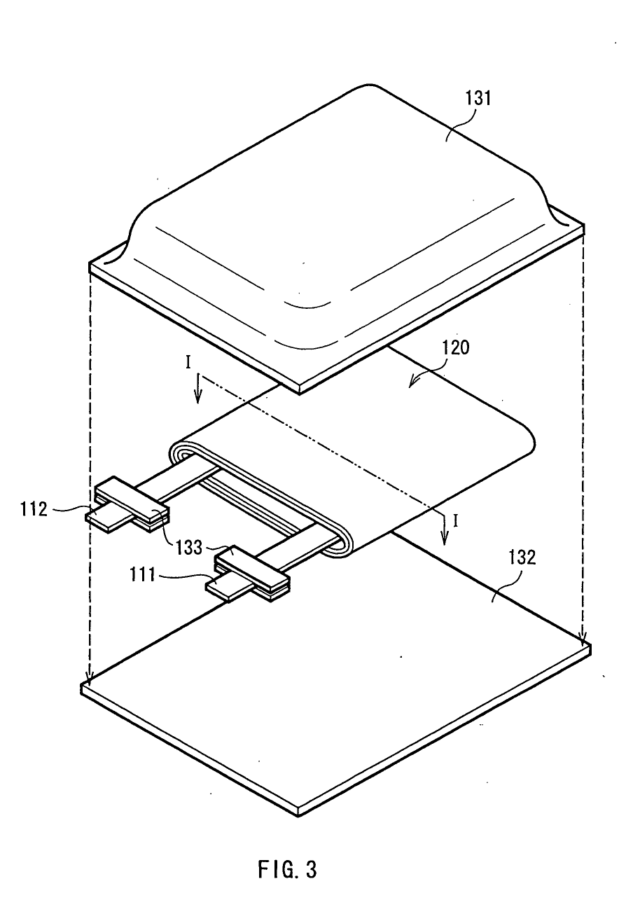

FIG. 3 shows a construction of the secondary battery. This secondary battery is a secondary battery wherein an electrode winding body 120 to which leads 111 and 112 are attached is housed inside film exterior members 131 and 132, and its size, weight and thickness can be reduced.

The leads 111 and 112 are directed from inside of the exterior members 131 and 132 to outside thereof, and, for example, are derived in the same direction. The leads 111 and 112 are respectively made of a metal material such as aluminum, copper, nickel, and stainless, and are respectively in the shape of a thin plate or in the shape of a net.

The exterior members 131 and 132 are made of an aluminum laminated film in the shape of a rectangle, wherein, for example, a nylon film, an aluminum foil, and a polyethylene film are bonded together in this order. The exterior members 131 and 132 are, for example, arranged so that the polyethylene film side and the electrode winding body 120 are placed opposite, and respective outer edge parts thereof are fusion-bonded or adhered to each other. Adhesive films 133 to protect from outside air intrusion are inserted between the exterior members 131, 132, and the leads 111, 112. The adhesive films 133 are made of a material having contact characteristics to the leads 111 and 112, for example, a polyolefin resin such as polyethylene, polypropylene, modified polyethylene, and modified polypropylene.

The exterior members 131 and 132 can be made of a laminated film having other structure, a high molecular weight film such as polypropylene, or a metal film, instead of the foregoing aluminum laminated film.

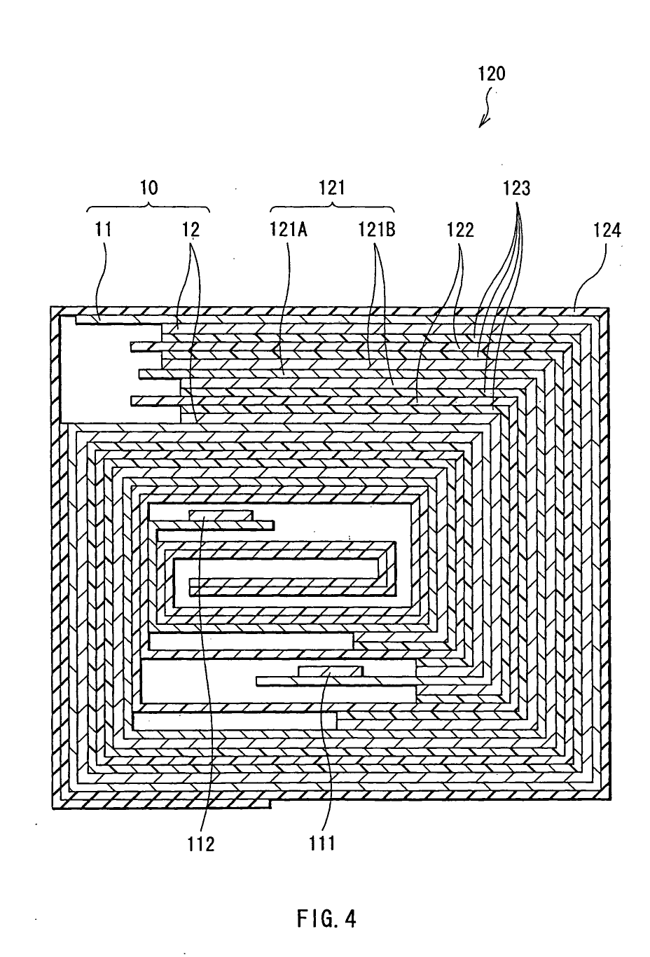

FIG. 4 shows a cross sectional structure taken along line I-I of the electrode winding body 120 shown in FIG. 3. In the electrode winding body 120, the anode 10 and a cathode 121 are layered and wound with a separator 122 and electrolyte layer 123 in between, and an outermost part thereof is protected by a protective tape 124.

The anode 10 has a structure wherein the anode active material layer 12 is provided on a single side or both sides of the anode current collector 11. Lithium is previously inserted in the anode 10 before initial charge (before initial charge and discharge). The cathode 121 also has a structure wherein cathode active material layers 121B are provided on a single side or both sides of a cathode current collector 121A. Arrangement is made so that the cathode active material layer 121B side faces to the anode active material layer 12. Constructions of the cathode current collector 121A, the cathode active material layer 121B, and the separator 122 are similar to that of the foregoing cathode current collector 41, the cathode active material layer 42, and the separator 50.

The electrolyte layer 123 is made of a so-called gelatinous electrolyte, wherein an electrolytic solution is held in a holding body. The gelatinous electrolyte is preferable since the gelatinous electrolyte can provide high ion conductivity and can prevent liquid leakage of the battery or expansion at high temperatures. A construction of the electrolytic solution (that is, a solvent and an electrolyte salt) is similar to that of the coin type secondary battery shown in FIG. 2. The holding body is made of, for example, a high molecular weight compound material. Examples of the high molecular weight compound material include polyvinylidene fluoride.

This secondary battery can be, for example, manufactured as follows.

First, the electrolyte layers 123 wherein the electrolytic solution is held in the holding body are formed on the anode 10 and the cathode 121, respectively. After that, the lead 111 is attached to an end of the anode current collector 11 by welding, and the lead 112 is attached to an end of the cathode current collector 121A by welding. Next, after making a lamination by layering the anode 10 and the cathode 121 on which the electrolyte layers 123 are formed with the separator 122 in between, this lamination is wound in its longitudinal direction, the protective tape 124 is bonded to the outermost circumferential part to form the electrode winding body 120. Finally, for example, the electrode winding body 120 is sandwiched between the exterior members 131 and 132, and the electrode winding body 120 is enclosed by contacting outer edges of the exterior members 131 and 132 by thermal fusion bonding or the like. Then, the adhesive films 133 are inserted between the leads 111, 112 and the exterior members 131, 132. Consequently, the secondary battery shown in FIGS. 3 and 4 is completed.

This secondary battery operates similar to the coin type secondary battery shown in FIG. 2 does.

As above, in this embodiment, lithium of from 0.5% to 40% of the anode capacity is inserted in the anode 10 before initial charge (before initial charge and discharge). Therefore, the film can be formed on the surface of the anode 10 from the previously inserted lithium, and consumption of lithium due to reaction with the electrolytic solution or the like can be inhibited at early cycles. Further, even when lithium is consumed, lithium can be refilled, and early deterioration can be inhibited. Furthermore, potential raise of the anode 10 can be inhibited in the final stage of discharge, and deterioration with the potential raise of the anode 10 can be inhibited. In addition, by previously inserting lithium, stress on the anode current collector 11 due to expansion and shrinkage of the anode active material layer 12 with charge and discharge can be reduced. In the result, battery characteristics such as cycle characteristics can be improved.

In particular, when an amount of previously inserted lithium is in the range from 0.02 μm to 20 μm per unit area by converting to a thickness of metallic lithium, higher effect can be obtained, and handling characteristics and manufacturing characteristics can be improved.

Further, when lithium is inserted by depositing metallic lithium on the anode active material layer 12 by vapor-phase deposition method, an amount of lithium to be inserted can be easily controlled, and lithium can be inserted uniformly over a large area. Further, since lithium can be inserted in the anode active material layer 12 in the process of depositing metallic lithium, the anode 10 can be handled easily. Furthermore, when the anode active material layer 12 is formed by vapor-phase deposition method, continuous deposition is available, and manufacturing processes can be simplified.

Further, when the anode active material layer 12 contains at least one from the group consisting of simple substances, alloys, and compounds of silicon or germanium, a high capacity can be obtained, and capacity loss due to previous insertion of lithium can be reduced. Further, by inserting lithium, dangling bond, or impurities such as hydrogen and oxygen, which exist in the anode active material layer 12 can be reduced, and battery characteristics such as cycle characteristics can be improved.

In addition, when the anode 10 has electrochemically active lithium after discharge at least at early charge and discharge cycles, sufficient lithium can be refilled even when lithium is consumed due to reaction with the electrolytic solution, and deterioration which is significantly generated particularly in the early charge and discharge cycles can be inhibited. Further, potential raise of the anode 10 in the final stage of discharge can be further inhibited, and deterioration with the potential raise of the anode 10 can be further inhibited. In the result, battery characteristics such as cycle characteristics can be further improved.

Furthermore, when the amount of lithium previously inserted in the anode active material layer 12 is 5% or more of the anode capacity, cycle characteristics can be further improved, and the capacity can be improved.

### EXAMPLES

Further, concrete descriptions will be given of examples of the invention with reference to FIGS. 1 to 4. In the following examples, reference numbers and symbols used in the foregoing embodiment are correspondingly used.

### Examples 1-1 to 1-7

Coin type secondary batteries as shown in FIG. 2 were fabricated. First, the anode active material layer 12 made of silicon was formed on the anode current collector 11 made of a copper foil having a thickness of 15 μm by sputtering. Next, metallic lithium was deposited on the anode active material layer 12 by vacuum deposition method. An atmosphere in depositing metallic lithium was under 1×10⁻³ Pa and a deposition rate was larger than 5 nm/s. An amount of metallic lithium to be deposited, that is, an amount of lithium to be previously inserted in the anode active material layer 12 was sequentially changed as 0.5% , 1%, 5% , 10%, 20%, 30%, and 40% of a lithium insertion capacity the anode active material layer 12 had, correspondingly to Examples 1-1 to 1-7. A thickness of the anode active material layer 12 was set so that a resultant capacity from subtracting a lithium capacity previously inserted from a capacity the anode active material layer 12 had could be constant. That is, the thickness of the anode active material layer 12 was 5.03 μm in Example 1-1, 5.05 μm in Example 1-2, 5.26 μm in Example 1-3, 5.56 μm in Example 1-4, 6.25 μm in Example 1-5, 7.14 μm in Example 1-6, and 8.33 μm in Example 1-7. The thickness of the anode active material layer 12 was confirmed by SEM (Scanning Electron Microscope).

After metallic lithium was deposited, argon gas was injected in a vacuum bath to obtain an ambient pressure, and the anode 10 was taken out. In this stage, the metallic lithium was already alloyed with and inserted in the anode active material layer 12, and did not exist as metallic lithium. The anodes 10 of Examples 1-1 to 1-7 were thereby obtained.

Subsequently, cobalt acid lithium (LiCoO₂) powders having an average particle diameter of 5 μm as a cathode active material; carbon black as a conductive material; and polyvinylidene fluoride as a binder were mixed at a mass ratio of cobalt acid lithium:carbon black:polyvinylidene fluoride=92:3:5. The resultant mixture was put in N-methyl pyrrolidone, which is a dispersion solvent, to obtain an admixture slurry. After that, the cathode current collector 41 made of aluminum having a thickness of 15 μm was coated with the admixture slurry, dried, and pressurized to form the cathode active material layer 42. The cathode 40 was thereby fabricated.

Next, the fabricated anode 10 and the cathode 40 were layered with the separator 50 in which an electrolytic solution is impregnated in between. The resultant lamination was inserted in the exterior cup 20 and the exterior can 30, and enclosed by performing caulking. As an electrolytic solution, an electrolytic solution wherein LiPF₆ as a lithium salt was dissolved in a solvent in which ethylene carbonate and dimethyl carbonate were mixed at a mass ratio of 1:1, so that the LiPF₆ became 1.0 mol/dm³ was used. As the separator 50, a polypropylene film was used. Secondary batteries of Examples 1-1 to 1-7 were thereby obtained. Dimensions of the battery were 20 mm in diameter and 16 mm in thickness.

Regarding the fabricated secondary batteries of Examples 1-1 to 1-7, a charge and discharge test was conducted under the condition of 25° C., and capacity retention ratios at the 50th cycle were obtained. Charge was conducted until a battery voltage reached 4.2 V at a constant current density of 1 mA/cm², and then charge was conducted until a current density reached 0.02 mA/cm² at a constant voltage of 4.2 V. Discharge was conducted until a battery voltage reached 2.5 V at a constant current density of 1 mA/cm². When charge was conducted, an initial utilization ratio of a resultant capacity from subtracting the previously inserted lithium amount from the capacity of the anode 10 was set to 90% to prevent metallic lithium from being precipitated on the anode 10. The capacity retention ratio at the 50th cycle was calculated as a proportion of a discharge capacity at the 50th cycle to an initial discharge capacity, that is, (discharge capacity at the 50th cycle/initial discharge capacity)×100. Obtained results are shown in Table 1.

TABLE 1

| | | Thickness of | | | |
|---|---|---|---|---|---|
| | | anode active | | | Capacity |
| | Anode active | material layer | Li insertion | | retention ratio |
| | material | (μm) | amount (%) | Residual Li | (%) |
| Example 1-1 | Si | 5.03 | 0.5 | Not present | 88 |
| Example 1-2 | Si | 5.05 | 1 | Not present | 92 |
| Example 1-3 | Si | 5.26 | 5 | Present | 95 |
| Example 1-4 | Si | 5.56 | 10 | Present | 98 |
| Example 1-5 | Si | 6.25 | 20 | Present | 97 |
| Example 1-6 | Si | 7.14 | 30 | Present | 95 |
| Example 1-7 | Si | 8.33 | 40 | Present | 95 |
| Comparative | Si | 5.00 | 0 | Not present | 71 |
| example 1-1 | | | | | |
| Comparative | Si | 5.02 | 0.3 | Not present | 73 |
| example 1-2 | | | | | |
| Comparative | Si | 10.00 | 50 | — | — |
| example 1-3 | | | | | |

Further, regarding the secondary batteries of Examples 1-1 to 1-7, after finishing discharge at the first cycle, the battery was deconstructed, the anode 10 was taken out and washed with dimethyl carbonate. Then, a coin type semi cell using the anode 10 as a working electrode was fabricated. As an electrolyte, an electrolytic solution wherein LIPF₆ as a lithium salt was dissolved in a solvent in which ethylene carbonate and dimethyl carbonate were mixed at a mass ratio of 1:1, so that the LiPF₆ became 1.0 mol/dm³ was used. As a separator, a polypropylene film was used, and as a counter electrode, a metallic lithium foil was used.

Regarding the fabricated semi cells, in order to extract lithium from the working electrode, electrolyzation was conducted until potential difference between the both electrodes reached 1.4 V at a constant current density of 0.06 mA/cm², and then electrolyzation was conducted until a current density reached 0.02 mA/cm² at a constant voltage of 1.4 V. In the result, electric charge corresponding to extraction of lithium was observed from the working electrode in Examples 1-3 to 1-7, and not observed in Examples 1-1 and 1-2. That is, it was found that electrochemically active lithium remained in the anode 10 in the secondary batteries of Examples 1-3 to 1-7 even after discharge. In the column of “Residual Li” of Table 1, “Present” is shown for Examples 1-3 to 1-7, and “Not present” is shown for Examples 1-1 and 1-2.

As Comparative example 1-1 in relation to Examples 1-1 to 1-7, an anode was fabricated as in Examples 1-1 to 1-7, except that lithium was not previously inserted in the anode. As Comparative examples 1-2 and 1-3 in relation to Examples 1-1 to 1-7, anodes were fabricated as in Examples 1-1 to 1-7, except that an amount of lithium to be previously inserted in the anode was 0.3% or 50% of the lithium insertion capacity the anode active material layer had. Further, by using the fabricated anodes of Comparative examples 1-1 to 1-3, secondary batteries were fabricated as in Examples 1-1 to 1-7. Regarding comparative example 1-3, the anode thereof was deformed too much due to insertion of lithium, and therefore, the battery thereof could not be fabricated.

Regarding the secondary batteries of Comparative examples 1-1 and 1-2, the charge and discharge test was also conducted as in Examples 1-1 to 1-7, and capacity retention ratios thereof at the 50th cycle were obtained. Results thereof are shown in Table 1 as well. Further, as in Examples 1-1 to 1-7, after discharge at the first cycle was finished, the anode was taken out to fabricate a half cell, and whether lithium was extracted from the working electrode or not was checked. In the result, electric charge corresponding to extraction of lithium was not observed from the working electrode. Therefore, it was found that electrochemically active lithium did not remain in the anodes of the secondary batteries of Comparative examples 1-1 and 1-2 after discharge. In the column of “Residual Li” of Table 1, “Not present” is shown for Comparative examples 1-1 and 1-2.

As evidenced by Table 1, according to Examples 1-1 to 1-7, wherein lithium was previously inserted in the anode 10, higher capacity retention ratios were obtained compared to Comparative example 1-1, wherein lithium was not inserted and Comparative example 1-2, wherein lithium insertion amount was small. That is, it was found that when lithium of 0.5% or more of the anode capacity was previously inserted in the anode 10, cycle characteristics could be improved.

In Comparative example 1-3, wherein the amount of lithium previously inserted was 50%, the anode was deformed too much, and it was difficult to fabricate a battery. That is, it was found that an amount of lithium previously inserted in the anode 10 was preferably 40% or less of the anode capacity.

Further, according to Examples 1-3 to 1-7, wherein electrochemically active lithium remained in the anode 10 after discharge, higher capacity retention ratios were obtained compared to Examples 1-1 and 1-2, wherein electrochemically active lithium did not remain in the anode 10 after discharge. That is, it was found that when the anode 10 had electrochemically active lithium after discharge, cycle characteristics could be further improved.

### Examples 2-1 to 2-7

The anodes 10 of Examples 2-1 to 2-7 and secondary batteries thereof were fabricated as in Examples 1-1 to 1-7, except that the anode active material layer 12 was formed with germanium by sputtering. As Comparative examples 2-1 to 2-3 in relation to Examples 2-1 to 2-7, anodes and secondary batteries thereof were fabricated as in Examples 2-1 to 2-7, except that an amount of lithium to be previously inserted in the anode was changed as shown in Table 2. However, regarding Comparative example 2-3, as in Comparative example 1-3, the anode was deformed too much due to insertion of lithium, and a battery could not be fabricated. Regarding the fabricated secondary batteries of Examples 2-1 to 2-7 and Comparative examples 2-1 and 2-2, the charge and discharge test was conducted as in Examples 1-1 to 1-7, and capacity retention ratios at the 50th cycle were obtained. Further, as in Examples 1-1 to 1-7, after discharge at the first cycle was finished, the anode 10 was taken out to fabricate a half cell, and whether electrochemically active lithium remained in the anode 10 or not was checked. Results thereof are shown in Table 2.

TABLE 2

| | | Thickness of | | | |
|---|---|---|---|---|---|
| | | anode active | | | Capacity |
| | Anode active | material layer | Li insertion | | retention ratio |
| | material | (μm) | amount (%) | Residual Li | (%) |
| Example 2-1 | Ge | 5.03 | 0.5 | Not present | 83 |
| Example 2-2 | Ge | 5.05 | 1 | Not present | 86 |
| Example 2-3 | Ge | 5.26 | 5 | Present | 89 |
| Example 2-4 | Ge | 5.56 | 10 | Present | 92 |
| Example 2-5 | Ge | 6.25 | 20 | Present | 90 |
| Example 2-6 | Ge | 7.14 | 30 | Present | 92 |
| Example 2-7 | Ge | 8.33 | 40 | Present | 90 |
| Comparative | Ge | 5.00 | 0 | Not present | 68 |
| example 2-1 | | | | | |
| Comparative | Ge | 5.02 | 0.3 | Not present | 71 |
| example 2-2 | | | | | |
| Comparative | Ge | 10.00 | 50 | — | — |
| example 2-3 | | | | | |

As evidenced by Table 2, as in Examples 1-1 to 1-7, according to Examples 2-1 to 2-7, wherein lithium was previously inserted in the anode 10, higher capacity retention ratios were obtained compared to Comparative example 2-1, wherein lithium was not inserted and Comparative example 2-2, wherein lithium insertion amount was small. That is, it was found that even if germanium was used as an anode active material, when lithium of 0.5% or more of the anode capacity was previously inserted in the anode 10, cycle characteristics could be improved as in the case using silicon.

Further, in Comparative example 2-3, wherein the amount of lithium previously inserted was 50%, it was difficult to fabricate a battery as in Comparative example 1-3. That is, it was found that an amount of lithium previously inserted in the anode 10 was preferably 40% or less of the anode capacity.

Further, according to Examples 2-3 to 2-7, wherein electrochemically active lithium remained in the anode 10 after discharge, higher capacity retention ratios were obtained compared to Examples 2-1 and 2-2, wherein electrochemically active lithium did not remain in the anode 10 after discharge. That is, it was found that when the anode 10 had electrochemically active lithium after discharge, cycle characteristics could be further improved.

### Examples 3-1 and 3-2

The anodes 10 and secondary batteries thereof were fabricated as in Examples 1-1 to 1-7, except that a thickness of the anode active material layer 12 was 0.60 μm or 0.45 μm, and an amount of lithium to be previously inserted was 1% of a lithium insertion capacity the anode active material layer 12 had. In Example 3-1, the amount of lithium previously inserted was 0.026 μm by converting to a thickness of metallic lithium per unit area, and in Example 3-2, the amount of lithium previously inserted was 0.019 μm by converting to a thickness of metallic lithium per unit area. As Comparative example 3-1 in relation to Examples 3-1 and 3-2, an anode and a secondary battery thereof were fabricated as in Examples 3-1 and 3-2, except that a thickness of the anode active material layer 12 was 0.45 μm and lithium was not previously inserted. Regarding the fabricated secondary batteries of Examples 3-1 and 3-2 and Comparative example 3-1, the charge and discharge test was conducted as in Examples 1-1 to 1-7, and capacity retention ratios at the 50th cycle were obtained. Results thereof are shown in Table 3.

TABLE 3

| | | Thickness of | | | |
|---|---|---|---|---|---|
| | | anode active | | Thickness of | Capacity |
| | Anode active | material layer | Li insertion | metallic Li | retention ratio |
| | material | (μm) | amount (%) | (μm) | (%) |
| Example 3-1 | Si | 0.60 | 1 | 0.026 | 95 |
| Example 3-2 | Si | 0.45 | 1 | 0.019 | 85 |
| Comparative | Si | 0.45 | 0 | — | 83 |
| example 3-1 | | | | | |

As evidenced by Table 3, according to Examples 3-1 and 3-2, wherein lithium was previously inserted in the anode 10, higher capacity retention ratios were obtained compared to Comparative example 3-1, wherein lithium was not inserted. When Example 3-1 is compared to Example 3-2, a higher capacity retention ratio was obtained in Example 3-1, wherein the amount of lithium previously inserted was 0.026 μm by converting to a thickness of metallic lithium per unit area, than in Example 3-2, wherein an amount of lithium previously inserted was 0.019 μm by converting to a thickness of metallic lithium per unit area. That is, it was found that the amount of lithium previously inserted was preferably 0.02 μm or more by converting to a thickness of metallic lithium per unit area.

In the foregoing Examples, the anode active material layer 12 was formed by sputtering, and metallic lithium was deposited by vacuum deposition method. However, similar results can be obtained when the anode active material layer 12 is formed by other methods.

### Examples 4-1 to 4-4

Secondary batteries shown in FIGS. 3 and 4 were fabricated. The anodes 10 were fabricated as in Example 1-1 to 1-7. An amount of metallic lithium to be deposited, that is, an amount of lithium to be previously inserted in the anode active material layer 12 was sequentially changed as 5% , 10%, 20%, and 30% of a lithium insertion capacity the anode active material layer 12 had, correspondingly to Examples 4-1 to 4-4. A thickness of the anode active material layer 12 was set so that a resultant capacity from subtracting a lithium capacity to be previously inserted from a capacity the anode active material layer 12 had could be constant. That is, the thickness of the anode active material layer 12 was 5.26 μm in Example 4-1, 5.56 μm in Example 4-2, 6.25 μm in Example 4-3 , and 7.14 μm in Example 4-4.

After metallic lithium was deposited, argon gas was injected in a vacuum bath to obtain an ambient pressure, and the anode 10 was taken out. In this stage, the metallic lithium was already alloyed with and inserted in the anode active material layer 12, and did not exist as metallic lithium.

Further, the cathodes 121 were fabricated as in Examples 1-1 to 1-7. After the anode 10 and the cathode 121 were fabricated, the anode 10 and the cathode 121 were coated with a precursor solution, wherein 10 wt % of polyvinylidene fluoride as a block copolymer of 0.6 million weight-average molecular weight and 60 wt % of dimethyl carbonate were mixed and dissolved in 30 wt % of electrolytic solution consisting of 42.5 wt % of ethylene carbonate, 42.5 wt % of propylene carbonate, and 15 wt % of LiPF₆ as a lithium salt. The resultant was left for eight hours at ambient temperatures, and dimethyl carbonate was volatilized. The electrolyte layer 123 was thereby formed.

After the electrolyte layer 123 was formed, the anode 10 and the cathode 121 on which the electrolyte layers 123 were formed were layered with the separator 122 in between, the resultant lamination was wound in its longitudinal direction, the protective tape 124 was bonded to the outermost circumferential part to form the electrode winding body 120. A polypropylene film was used for the separator 122. After that, the electrode winding body 120 was sandwiched between the exterior members 131 and 132 made of aluminum laminated films, and the electrode winding body 120 was enclosed therein. The secondary batteries of Examples 4-1 to 4-4 were thereby obtained.

Regarding the fabricated secondary batteries of Examples 4-1 to 4-4, the charge and discharge test was conducted as in Examples 1-1 to 1-7, and capacity retention ratios at the 50th cycle were obtained. Further, after discharge at the third cycle was finished, the anode 10 was taken out to fabricate a half cell as in Examples 1-1 to 1-7, and whether electrochemically active lithium remained in the anode 10 or not was checked. Results thereof are shown in Table 4.

TABLE 4

| | | Thickness of | | | |
|---|---|---|---|---|---|
| | | anode active | | | Capacity |
| | Anode active | material layer | Li insertion | | retention ratio |
| | material | (μm) | amount (%) | Residual Li | (%) |
| Example 4-1 | Si | 5.26 | 5 | Present | 95 |
| Example 4-2 | Si | 5.56 | 10 | Present | 97 |
| Example 4-3 | Si | 6.25 | 20 | Present | 97 |
| Example 4-4 | Si | 7.14 | 30 | Present | 96 |
| Comparative | Si | 5.00 | 0 | Not present | 73 |
| example 4-1 | | | | | |

As Comparative example 4-1 in relation to Examples 4-1 to 4-4, a secondary battery was fabricated as in Examples 4-1 to 4-4, except that lithium was not previously inserted in the anode. Regarding the secondary battery of Comparative example 4-1, the charge and discharge test was conducted as in Examples 4-1 to 4-4, and a capacity retention ratio at the 50th cycle was obtained. Further, after discharge at the first cycle was finished, the anode was taken out to fabricate a half cell, and whether lithium was extracted from a working electrode or not was checked. Results thereof are shown in Table 4 as well.

As evidenced by Table 4, according to Examples 4-1 to 4-4, wherein electrochemically active lithium remained in the anode 10 after discharge, higher capacity retention ratios were obtained compared to Comparative example 4-1, wherein electrochemically active lithium did not remain. That is, it was found that when the anode 10 had electrochemically active lithium after discharge, cycle characteristics could be improved regardless of shapes of batteries.

### Examples 5-1 to 5-4

The anodes 10 of Examples 5-1 to 5-4 and secondary batteries thereof were fabricated as in Examples 4-1 to 4-4, except that the anode active material layer 12 was formed with germanium by sputtering. As Comparative example 5-1 in relation to Examples 5-1 to 5-4, an anode and a secondary battery thereof were fabricated as in Examples 5-1 to 5-4, except that lithium was not previously inserted in the anode. Regarding the fabricated secondary batteries of Examples 5-1 to 5-4 and Comparative example 5-1, the charge and discharge test was conducted as in Examples 4-1 to 4-4, and capacity retention ratios at the 50th cycle were obtained. Further, after discharge, the anode 10 was taken out to fabricate a half cell, and whether electrochemically active lithium remained or not in the anode 10 after discharge at the third cycle for Examples 5-1 to 5-4 and after discharge at the first cycle for Comparative example 5-1 was checked. Results thereof are shown in Table 5.

TABLE 5

| | | Thickness of | | | |
|---|---|---|---|---|---|
| | | anode active | | | Capacity |
| | Anode active | material layer | Li insertion | | retention ratio |
| | material | (μm) | amount (%) | Residual Li | (%) |
| Example 5-1 | Ge | 5.26 | 5 | Present | 90 |
| Example 5-2 | Ge | 5.56 | 10 | Present | 92 |
| Example 5-3 | Ge | 6.25 | 20 | Present | 91 |
| Example 5-4 | Ge | 7.14 | 30 | Present | 93 |
| Comparative | Ge | 5.00 | 0 | Not present | 70 |
| example 5-1 | | | | | |

As shown in Table 5, in Examples 5-1 to 5-4, electrochemically active lithium remained after discharge. Meanwhile, in Comparative example 5-1, electrochemically active lithium did not remain after discharge. Further, as in Examples 4-1 to 4-4, according to Examples 5-1 to 5-4, higher capacity retention ratios were obtained compared to Comparative example 5-1. That is, it was found that even when germanium was used as an anode active material, when electrochemically active lithium remained in the anode 10 after discharge, cycle characteristics could be improved regardless of shapes of batteries.

### Examples 6-1 to 6-4

Secondary batteries were fabricated as in Examples 4-1 to 4-4, except that the anode 10 was fabricated by forming the anode active material layer 12 made of tin having a thickness of 5 μm on the anode current collector 11 made of a copper foil having a thickness of 15 μm by vacuum deposition method, subsequently performing heat treatment for 12 hours at 200° C. under an inert atmosphere, and then depositing metallic lithium on the anode active material layer 12 by vacuum deposition method. As Comparative example 6-1 in relation to Examples 6-1 to 6-4, an anode and a secondary battery thereof were fabricated as in Examples 6-1 to 6-4, except that lithium was not previously inserted in the anode. Regarding the fabricated secondary batteries of Examples 6-1 to 6-4 and Comparative example 6-1, the charge and discharge test was conducted as in Examples 4-1 to 4-4, and capacity retention ratios at the 50th cycle were obtained. Further, after discharge, the anode 10 was taken out to fabricate a half cell, and whether electrochemically active lithium remained in the anode 10 or not after discharge at the third cycle for Examples 6-1 to 6-4 and after discharge at the first cycle for Comparative example 6-1 was checked. Results thereof are shown in Table 6.

TABLE 6

| | | Thickness of | | | |
|---|---|---|---|---|---|
| | | anode active | | | Capaicty |
| | Anode active | material layer | Li insertion | | retention ratio |
| | material | (μm) | amount (%) | Residual Li | (%) |
| Example 6-1 | Sn | 5.26 | 5 | Present | 56 |
| Example 6-2 | Sn | 5.56 | 10 | Present | 59 |
| Example 6-3 | Sn | 6.25 | 20 | Present | 68 |
| Example 6-4 | Sn | 7.14 | 30 | Present | 78 |
| Comparative | Sn | 5.00 | 0 | Not present | 48 |
| example 6-1 | | | | | |

As shown in Table 6, in Examples 6-1 to 6-4, electrochemically active lithium remained after discharge. Meanwhile, in Comparative example 6-1, electrochemically active lithium did not remain after discharge. Further, as in Examples 4-1 to 4-4 and 5-1 to 5-4, according to Examples 6-1 to 6-4, higher capacity retention ratios were obtained compared to Comparative example 6-1. That is, it was found that, as in the case using silicon or germanium, when tin was used as an anode active material, cycle characteristics could be improved as long as electrochemically active lithium remained in the anode 10 after discharge.

A secondary battery was fabricated and evaluated as in Examples 6-1 to 6-4, except that the anode active material layer 12 was formed by plating instead of vacuum deposition method. For this secondary battery, results similar to Examples 6-1 to 6-4 was obtained.

While the invention has been described with reference to the embodiment and Examples, the invention is not limited to the foregoing embodiment and Examples, and various changes may be made. For example, in the foregoing embodiment and Examples, descriptions have been given of the case wherein the high molecular weight material was used as a holding body for the electrolyte. However, an inorganic conductor containing lithium nitride or lithium phosphate can be used as a holding body. Further, a mixture of a high molecular weight material and an organic conductor can be used.

Further, in the foregoing embodiment and Examples, the anode 10 wherein the anode current collector 11 is provided with the anode active material layer 12 has been described. However, other layers can be provided between the anode current collector and the anode active material layer.

Further, in the foregoing embodiment and Examples, the coin type and the winding laminated type secondary batteries have been described. However, the invention can be applied similarly to secondary batteries such as cylinder type, square type, button type, thin type, large type and multilayer laminated type secondary batteries. Further, the invention can be applied not only to the secondary batteries, but also to primary batteries.

Obviously many modifications and variations of the present invention are possible in the light of the above teachings. It is therefore to be understood that within the scope of the appended claims the invention may be practiced otherwise than as specifically described.

1. An anode, comprising:
an anode current collector; and
an anode active material layer which is provided on the anode current collector and is alloyed with the anode current collector at least at part of an interface with the anode current collector,
wherein lithium of from 0.5% to 40% of an anode capacity is inserted therein.

2. An anode, comprising:
an anode current collector; and
an anode active material layer which is formed on the anode current collector by at least one method from the group consisting of vapor-phase deposition method, liquid-phase deposition method, and firing method,
wherein lithium of from 0.5% to 40% of an anode capacity is inserted therein.

3. An anode according to claim 2, wherein an insertion amount of the lithium is from 0.02 μm to 20 μm per unit area by converting to a thickness of metallic lithium.

4. An anode according to claim 2, wherein the lithium is inserted by depositing metallic lithium by vapor-phase deposition method.

5. An anode according to claim 2, wherein the anode active material layer is alloyed with the anode current collector at least at part of the interface with the anode current collector.

6. An anode according to claim 2, wherein the anode active material layer contains at least one from the group consisting of simple substances, alloys, and compounds of silicon (Si) or germanium (Ge).

7. A battery, comprising:
a cathode;
an anode; and
an electrolyte,
wherein the anode comprises an anode current collector and an anode active material layer which is provided on the anode current collector and is alloyed with the anode current collector at least at part of an interface with the anode current collector, and lithium of from 0.5% to 40% of an anode capacity is inserted therein before initial charge and discharge.

8. A battery, comprising:
a cathode;
an anode; and
an electrolyte,
wherein the anode comprises an anode current collector and an anode active material layer which is formed on the anode current collector by at least one method from the group consisting of vapor-phase deposition method, liquid-phase deposition method, and firing method, and lithium of from 0.5% to 40% of an anode capacity is inserted therein before initial charge and discharge.

9. A battery according to claim 8, wherein an insertion amount of the lithium is from 0.02 μm to 20 μm per unit area by converting to a thickness of metallic lithium.

10. A battery according to claim 8, wherein the lithium is inserted by depositing metallic lithium by vapor-phase deposition method.

11. A battery according to claim 8, wherein the anode active material layer is alloyed with the anode current collector at least at part of an interface with the anode current collector.

12. A battery according to claim 8, wherein the anode active material layer contains at least one from the group consisting of simple substances, alloys, and compounds of silicon (Si) or germanium (Ge).

13. A battery, comprising:
a cathode;
an anode; and
an electrolyte,
wherein the anode comprises an anode current collector and an anode active material layer which is provided on the anode current collector and is alloyed with the anode current collector at least at part of an interface with the anode current collector, and has therein electrochemically active residual lithium after discharge.

14. A battery, comprising:
a cathode;
an anode; and
an electrolyte,
wherein the anode comprises an anode current collector and an anode active material layer which is formed on the anode current collector by at least one method from the group consisting of vapor-phase deposition method, liquid-phase deposition method, and firing method, and has therein electrochemically active residual lithium after discharge.

15. A battery according to claim 14, wherein the anode active material layer is alloyed with the anode current collector at least at part of an interface with the anode current collector.

16. A battery according to claim 14, wherein the anode active material layer contains at least one from the group consisting of simple substances, alloys, and compounds of silicon (Si), germanium (Ge), or tin (Sn).
